(19) United States
(12) Patent Application Publication
(10) Pub. No.: US 2006/0036525 A1
(43) Pub. Date: Feb. 16, 2006

(54) Regulation compliance monitoring, reporting and documentation support system

(75) Inventors: Alexander Ramos, Ridgewood, NJ (US); Timothy Overzat, Warren, NJ (US); William J. Yung, Brooklyn, NY (US)

Correspondence Address: PILLSBURY WINTHROP SHAW PITTMAN, LLP, P.O. BOX 10500, MCLEAN, VA, 22102, US

(73) Assignee: THE BANK OF NEW YORK, New York, NY (US)

(21) Appl. No.: 11/196,725

(22) Filed: Aug. 4, 2005

Related U.S. Application Data
(60) Provisional application No. 60/601,140, filed on Aug. 13, 2004.

(51) Int. Cl. G06Q 40/00

(52) U.S. Cl. 705/35

(57) ABSTRACT

A system provides a plurality of functions associated with monitoring and reporting required by the SEC as well as data depository capabilities of use with those requirements. These functionalities and capabilities are provided in a web-based environment that is accessible by a user over a public and/or private network.

This application is related to and claims priority under 35 U.S.C. 120 from co-pending provisional U.S. Patent application No. 60/601,140, titled “Chief Compliance Officer Services Support System and Methodologies”, filed Aug. 13, 2004, and the concurrently filed, non-provisional U.S. patent application entitled “Cash Flow Monitoring Mechanism and Methodology,” the contents of which are incorporated herein by reference.

### BACKGROUND OF THE INVENTION

1. Field of the Invention

This invention relates to a system for, managing, documenting and supporting compliance with policies and procedures implemented in conjunction with rules and regulations promulgated by regulatory authorities.

2. Description of Related Art

The United States Securities and Exchange Commission (SEC) has mandated that mutual funds and their investment advisors perform increased monitoring and oversight to ensure compliance with United States federal securities laws. Section (38(a)-1 of the Investment Company Act (originally enacted 1940) and 206(4)-7 of the Investment Advisers Act (originally enacted 1940)—cumulatively referred to hereafter as the “new CCO rules”—require that investment companies registered in the United States and registered investment advisers: (1) adopt and implement written policies and procedures reasonably designed to prevent violations of federal securities laws; (2) designate a Chief Compliance Officer (CCO) responsible for administering those policies and procedures and reporting on their adequacy and effectiveness to mutual fund boards of directors; and (3) maintain specified documentation associated with those activities.

The implemented policies and procedures are meant to provide for the oversight of compliance by a fund's advisers, principal underwriters, administrators, and transfer agents (collectively, the fund's “service providers”). However, the new CCO rules are widely recognized to be flexible enough to allow application in a manner best suited for an organization. The policies and procedures also include provisions for oversight of service provider compliance. Funds may not simply rely on their service providers policies and procedures. However, funds may rely on a third-party to provide reporting on service provider compliance. Third-party reports must assess the adequacy of the service provider's compliance controls, describe the service provider's compliance program as it relates to the types of services provided to the fund and discuss the types of compliance risks material to the funds.

Also under the new CCO rules, all funds must maintain materials provided to their board of directors in connection with their approval of the policies and procedures of the fund and its service providers and the annual written reports by the fund's CCO, maintain copies of all policies and procedures that are in effect or were in effect at any time during the last five years and keep any records documenting their annual review. However, these records may be maintained electronically.

In adopting Rule 38a-1 under the Investment Company Act, a compliance rule, Rule 206(4)-7 was also adopted under the Investment Advisors Act. Under that new compliance rule, financial advisers' policies and procedures must address trading practices, proprietary trading of the adviser and personal trading by its supervised persons, the accuracy of disclosures to investors, clients, and regulators, including in account statements and advertising, safeguarding of client assets from conversion or inappropriate use by advisory personnel, the accurate creation of required records and their maintenance in a manner that secures them from unauthorized alteration, use, or destruction, marketing advisory services, including the use of solicitors, processes to value client holdings and assess fees, safeguards for the privacy protection of client records and information; and business continuity plans.

Rule 204-2 of the Advisers Act, which governs an adviser's recordkeeping requirements, has also recently been revised to require an adviser to maintain copies of all policies and procedures that are in effect or were in effect at any time during the past five year as well as any records documenting the adviser's annual review. However, these records may also be maintained electronically.

### SUMMARY OF THE INVENTION

In accordance with at least one embodiment of the invention, one or more systems provide a plurality of functions associated with monitoring and reporting required by the SEC as well as data depository capabilities of use with those requirements. These functionalities and capabilities are provided in a web-based environment that is accessible by a user over a public and/or private network. As such, the system provides what is referred to herein as a “CCO Support System.”

In accordance with at least one embodiment of the invention, a post trade compliance monitoring and reporting f unction is provided by the CCO Support System and is based on transaction activity data provided by a compliance data monitoring and reporting component that is integrated with the CCO Support System.

In accordance with at least one other embodiment of the invention, a post trade compliance monitoring and reporting function is provided based on transaction activity data provided by a compliance data monitoring and reporting component located remotely from the CCO Support System, e.g., located in-house at a Client of the CCO Support System, for example, an organization such as an investment company managing a mutual fund that is being monitored, reported on and supported by the CCO Support System.

### BRIEF DESCRIPTION OF THE DRAWINGS

Various embodiments of the invention are described herein wherein like reference numerals indicate like components.

FIG. 1 illustrates an example of an environment wherein one or more Clients of an organization providing the CCO Support System interact with the CCO Support System.

FIG. 2 illustrates details included in one exemplary architecture for implementing the CCO Support System.

FIG. 3 illustrates additional details of one exemplary architecture for the post trade compliance monitoring component included in the CCO Support System.

FIG. 4 illustrates additional details of one exemplary architecture for the valuation and cash flow monitoring component included in the CCO Support System.

FIG. 5 illustrates additional details of one exemplary architecture for the advisor tools component (specialized post-trade compliance monitoring developed outside of the post-trade compliance monitoring component referred to in FIG. 3.) included in the CCO Support System.

FIG. 6 illustrates additional details of one exemplary architecture for the market and regulatory data reference component included in the CCO Support System.

FIG. 7 illustrates additional details of one exemplary architecture for the fund data reference component included in the CCO Support System.

FIG. 8 illustrates additional details of one exemplary architecture for the advisor data reference component included in the CCO Support System.

FIG. 9 illustrates additional details of one exemplary architecture for the service provider data reference component included in the CCO Support System.

FIG. 10 illustrates one example of a potential configuration of a chart including information associated with monitoring for fund cash flows as generated by fund capital stock activity, i.e., the sale and redemption of a fund's capital shares.

FIG. 11 illustrates one example of a web-page configured as a home page for the CCO Support System.

FIG. 12 illustrates one example of market related literature to which access is granted by the CCO Support System.

FIG. 13 illustrates one example of a report generated by the CCO Support System.

FIG. 14 illustrates one example of a Fair Value Event Data and Effectiveness Summary report generated by the CCO Support System.

FIG. 15 illustrates one example of a Fair Valuation Data report generated by the CCO Support System.

FIG. 16 illustrates one example of a Vendor Effectiveness Data report generated by the CCO Support System.

### DETAILED DESCRIPTION OF THE INVENTION

Throughout the further explanation of the embodiments of the invention, the term “CCO” broadly refers to Chief Compliance Officers, their staff and personnel acting at their direction. Additionally, the term “Client” refers to a financial investment entity, e.g., an organization that is utilizing the services provided by the CCO Support System.

In accordance with at least one embodiment of the invention, the CCO Support System may include components configured to deliver functional data, on a timely basis, to assist a Client's CCO in measuring the effectiveness of fund and advisor policies and procedures designed to prevent the violation of federal securities laws. In doing so, the CCO Support System may also be configured to monitor and document post-trade compliance of Client portfolios, fund cash flows and fair valuation practices. Additionally, the CCO Support System may include components configured to provide a repository of documentation required to be maintained by the new CCO rules. Further, in accordance with at least one embodiment of the invention, the CCO Support System may include components that enable access to legal literature, industry and regulatory data, and proprietary fund information that is pertinent and directly applicable to the responsibilities of the CCO in carrying out their duties.

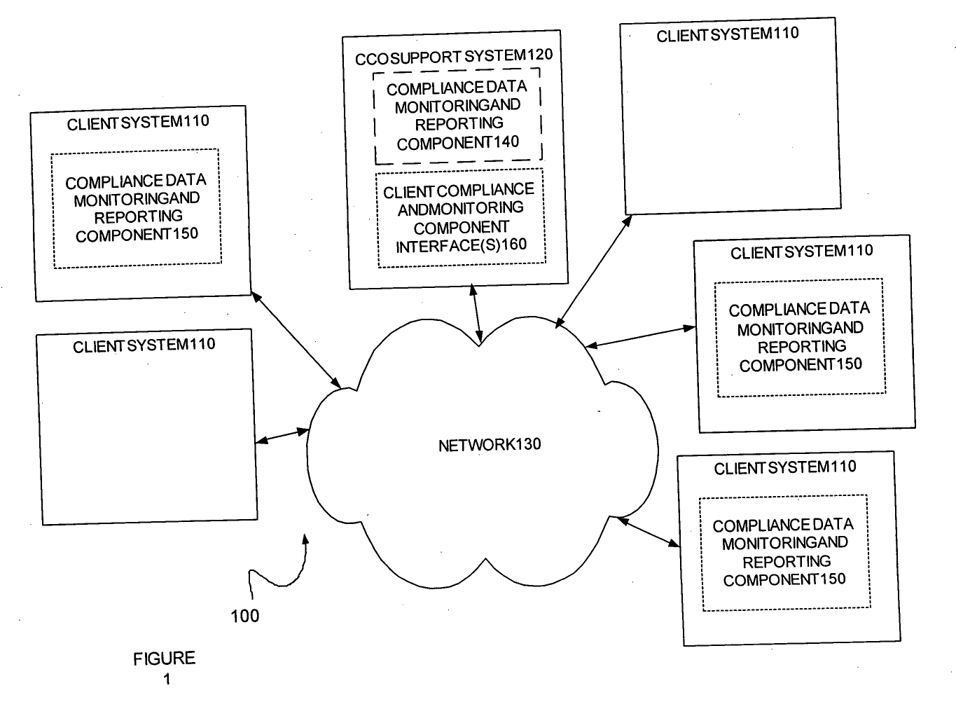

In accordance with at least one embodiment of the invention, the service delivery mechanism for the CCO Support System may be web-based. Thus, as illustrated in FIG. 1, an environment 100 may allow one or more Clients of an organization providing the CCO Support System, which may include their own systems referred to as Client systems 110, with access to the CCO Support System 120 via a communication network 130, which can be, for example, implemented in whole or part by the Internet and/or like networks. Additionally, a CCO may access services and information provided by the CCO Support System by accessing and interacting with one or more web-pages associated with or provided by the CCO Support System, as explained herein.

Thus, the CCO Support System may be implemented as a web-based service requiring no special equipment or add-ons for a Client CCO to install or use. Moreover, such a web-based service may provide access to documents, data and records requiring significant storage facilities without burdening a Client using the CCO Support System because such storage facilities function to store such document electronically and by the organization providing the CCO Support System rather then the Client. Such a configuration may provide for centralized electronic storage, maintenance and tracking of all of a Client's documentation to a third party, i.e., the organization providing the CCO Support System.

Moreover, the web-based service may provide easy access to a wealth of information administered by the CCO Support System. An added utility results from the nature of the CCO Support System as a central source/one-stop-shop for, for example, pertinent legal literature, regulatory and industry data, and proprietary fund information.

It should be understood that such a web-based implementation may include one or more security measures including user-input identification numbers and passwords, direct end-to-end, dedicated network connections, secure socket technology, and one or more encryption technologies.

As illustrated in FIG. 1, such Client systems 110 may or may not include their own in-house compliance data monitoring and reporting component, which may provide compliance data monitoring and reporting as required by various statutes and SEC regulations and guidelines. The CCO Support System 120 may be implemented using one or more servers (e.g., one or more server farms, a hierarchically configured server system where a first server acts as a proxy that receives requests from a number of users and routes the requests to appropriate server(s), etc.).

As illustrated in FIG. 1, a user (e.g., a Client CCO) may access the communication network 130 via the Client system 110. The Client system 110 may include any type of data processing device resident with a user, e.g., a PDA, a mobile phone, or other computer equipment resident at a user premises including, for example, a personal computer, etc. The communication network 130 may include, among other things, one or more public networks, such as the Internet, and/or one or more private networks often referred to as “Intranets” and “Extranets.” A connection between the Client system 110 and the communication network 130 may be provided by, for example, the Client's communication network, an Internet connection via a modem included in the Client system 110 and connected to traditional phone lines, an ISDN link, a T1 link, a T3 link, via cable television, via an ethernet network, etc.; that connection may be made, for example, via a third party, such as an Internet Service Provider (ISP) or wireless network. The connection may be made, for example, either by a direct connection of the Client/user to the Internet or indirectly via another, intermediary, device connected to the Internet; in the latter case, the Client system 110 may be connected to the intermediary device via a Local or Wide Area Network (LAN or WAN).

A user may access the CCO Support System 120 by establishing a connection, e.g., a TCP connection, between the Client system 110 and the CCO Support System 120. The Client system 110 may communicate with the CCO Support System 120 using, for example, HTTP protocol over such a TCP connection, to facilitate data transfer between the Client system 110 and the CCO Support System 120. Thus, communication between the CCO Support System 120 and the Client system 110 may be facilitated via a browser included in the Client system 110.

As explained above, in accordance with at least one embodiment of the invention, the CCO Support System generates data, reports and alerts based on fund accounting information maintained by the organization providing the CCO Support System on behalf of its Client(s) and their CCO(s) using a compliance data monitoring and reporting component 140 (illustrated in dashed lines to signify it only as an option associated with at least the first embodiment of the invention) that interfaces with fund accounting components. In such an embodiment, the Client has outsourced the fund accounting responsibilities to the CCO Support System organization, thereby eliminating the need to transmit data to the CCO Support System in order for that system to perform analysis and generate alerts and reports.

In accordance with at least another embodiment of the invention, the CCO Support System generates data, reports and alerts based on Client' fund accounting records generated by a Client's compliance data monitoring and reporting component 150 (illustrated in dashed lines to signify it only as an option associated with at least the first embodiment of the invention). Therefore, the CCO Support System has access to, at least periodically and in a timely manner (e.g., at set times throughout a business day and subsequent to daily market closings), the Client's fund accounting information generated by the component 150 in order to generate alerts and report data on a timely basis via the CCO Support System. Accordingly, in such an embodiment, the CCO Support System includes one or more interfaces 160 to Clients' fund accounting systems (illustrated in dashed lines to signify it only as an option associated with a configuration in which the CCO Support System is utilizing), and therefore, relying on, a Client's own fund accounting records.

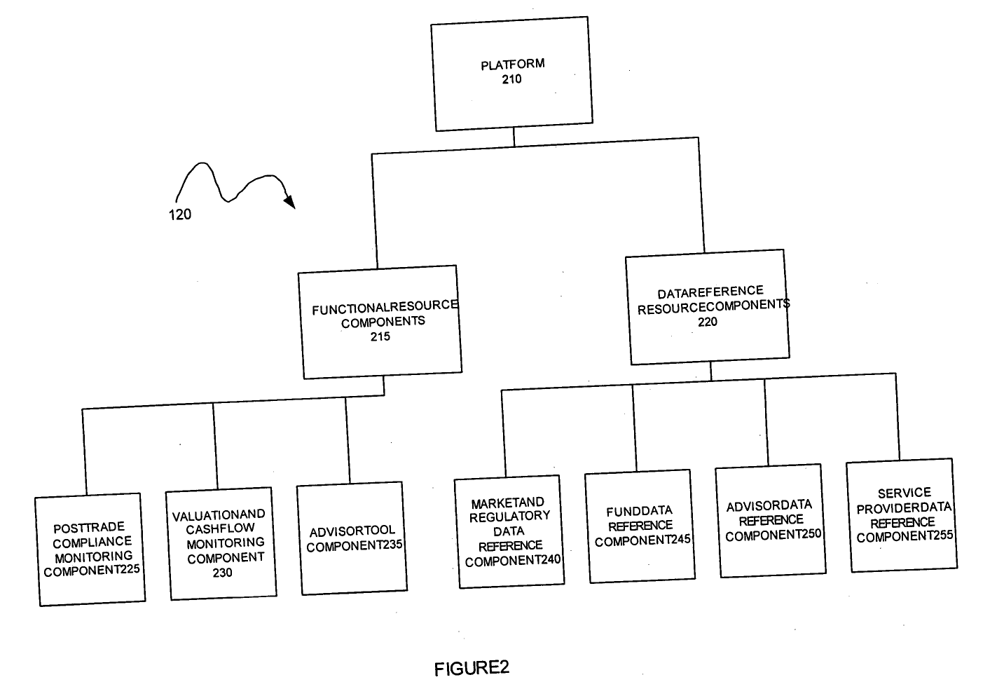

As illustrated in FIG. 2, the CCO Support System 120 may be configured in a hierarchical architecture in which the support system is implemented as part of or on a platform 210 providing Internet-based information delivery and security trading and transaction reporting to Clients. The platform 210 may be implemented as a web-based portal that includes and/or provides access to information provided by the organization maintaining and/or operating the CCO support system. Thus, the CCO Support System may be easily accessed through an integrated information delivery platform. That platform 210 may also provide access to data that is not that organization's own data but is related to the transactions supported by that organization; therefore, the platform may provide access to one or more systems for facilitating trading of securities and other financial instruments in a market. As mentioned above, in accordance with at least one embodiment, the platform 210 may be implemented as part of, in conjunction with or separate from an accounting platform that supports the daily fund accounting needs of the Clients of the organization providing the CCO Support System. Thus, the CCO Support System enables a user to link to other compliance services including those related to custody, fund accounting and data recordation.

Thus, the platform 210 may functionally provide a portal to information and services provided and/or maintained by the organization associated with the CCO Support System. Therefore, the Support System may provide and/or incorporate both functional resource components 215 and data reference resource components 220 (implemented, for example, using one or more software applications running on the platform 210 and accessing data stored in one or more data repositories implemented in databases and other memory maintained by the organization associated with the CCO Support System and other organizations).

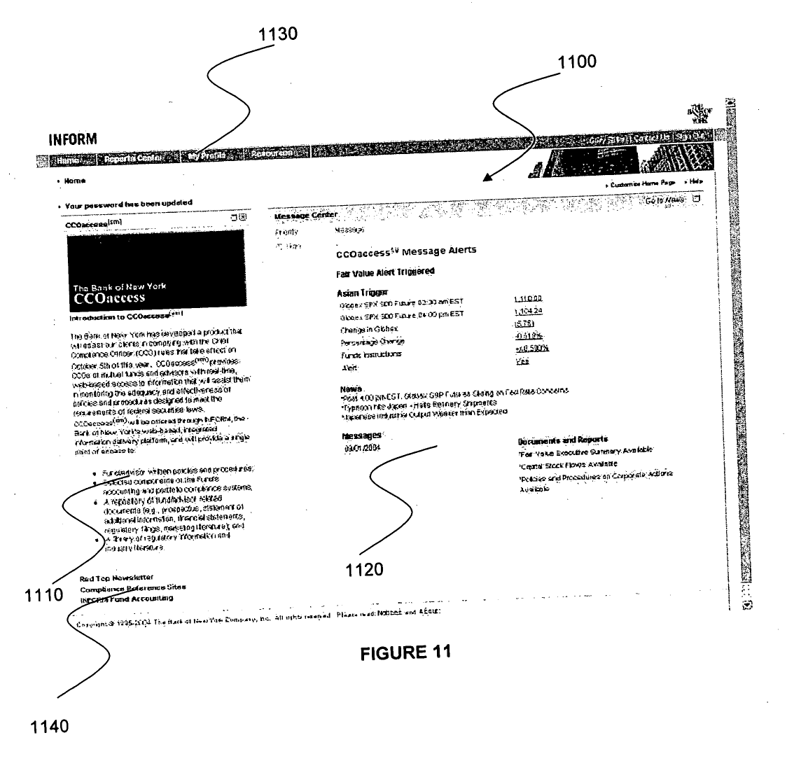

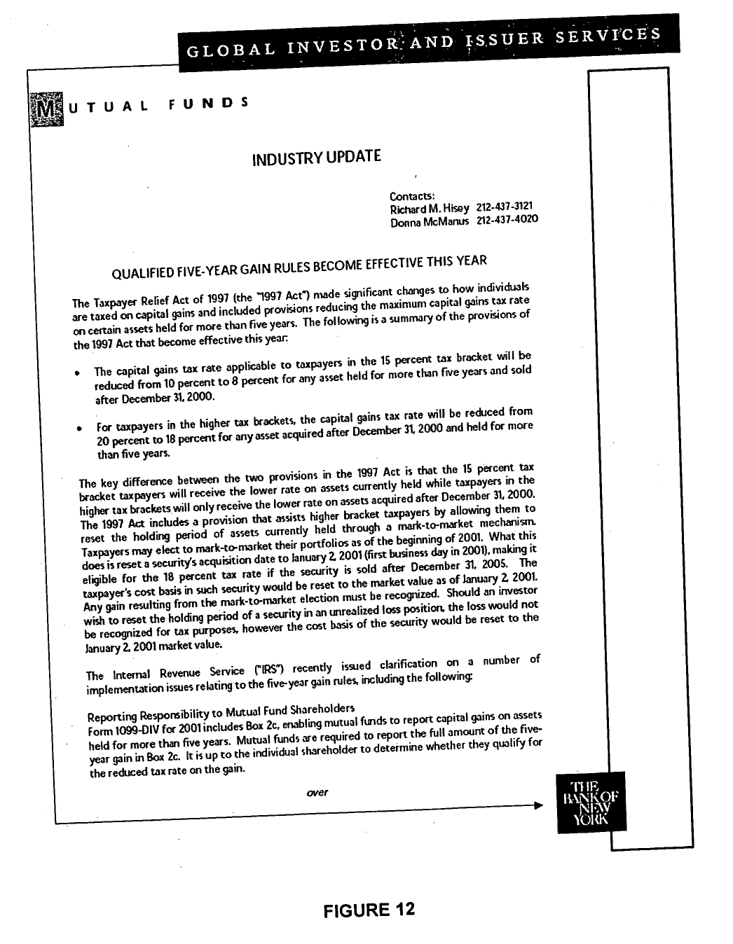

The functional resource components 215 may include, for example, a post-trade compliance monitoring component 225, a valuation and cash flow monitoring component 230 and an advisor tool component 235. Similarly, the data reference resource components 220 may include, for example, a market and regulatory data reference component 240, a fund data reference component 245, an advisor data reference component 250, and a service provider data reference component 255. As a result, the CCO Support System may provide high level functional reporting, specifically designed for a CCO to assist in the monitoring, analysis and recordation of a number of pieces of information required by various rules and regulations mandated by the SEC. Such monitoring and analysis may be provided to the CCO in the form of automated and/or, semi-automated reporting such as electronic alerts issued by the system on a timely basis, explained herein in more detail in relation to FIG. 12. These alerts may be generated based on fund accounting and compliance systems integrated with the CCO Support System within the organization providing the CCO Support System and/or such accounting and compliance systems utilized by the CCO's firm's own facilities. Such monitoring and analysis may also be provided on an ad hoc reporting basis by the manual running of reports using the resources provided by the CCO Support System's report center (explained in more detail in relation to FIG. 11) by Client CCOs.

Thus, the CCO Support System may include components configured to deliver functional data, on a timely basis, to assist a Client's CCO in measuring the effectiveness of fund and advisor policies and procedures designed to prevent the violation of federal securities laws.

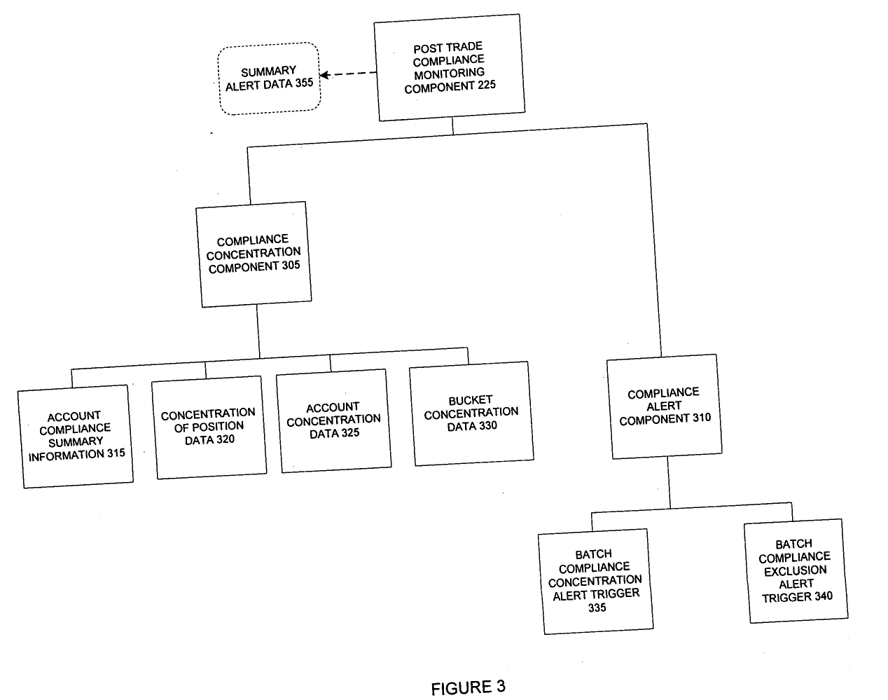

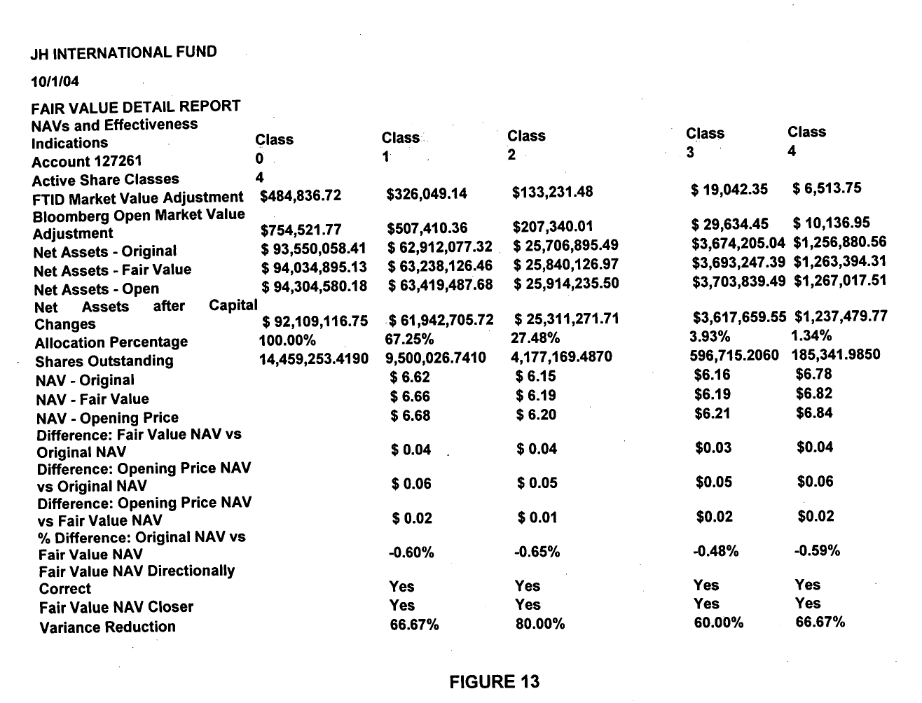

As illustrated in FIG. 3, the post trade compliance monitoring component 225, illustrated in FIG. 2, may include or provide access to, for example, a compliance concentration component 305 and a compliance alert component 310. The compliance concentration component 305 may include or provide access to various information and data necessary to allow a Client CCO to determine whether fund(s) are within the rules and requirements set forth by governmental entities and within the fund(s)' prospectus. Thus, the compliance concentration component 305 may provide information regarding concentration positions including account compliance summary information 315 which may summarize, for example, concentration of position data 320, account concentration data 325, bucket concentration data 330, etc. This information may be provided to a Client CCO as part of an alert or alert summary or in various reports accessible by the Client CCO, and discussed in more detail herein in relation to FIGS. 13-16.

As mentioned above, the compliance alert component 310 (along with similar alert components included in the CCO Support System) may be configured to generate various alerts based on trigger criteria associated with market and/or transaction criteria identified by the Client CCO and/or personnel within the organization maintaining or operating the CCO Support System. The use of such triggers enable the automated and semi-automated generation of message alerts dealing with portfolio compliance to warn a Client CCO that a portfolio has fallen outside of minimum or maximum concentrations in a particular country, region, industry, issuer, investment type, tax status, etc. Such triggers may include, for example, batch compliance concentration alert triggers that, when met, generate alerts to the Client CCO indicating both that the trigger has been met and providing related data that allow the Client CCO to determine how to proceed to ensure that the fund(s) are in compliance with relevant rules included in the fund(s)' prospectus as well as regulations of interested governmental entities.

Additionally, the compliance alert component 310 may be configured to provide manager alert summaries generated and transmitted to Client CCOs in the same and/or different manners then the alerts generated by the post trade compliance monitoring component 225. This alert summary may be provided to remind managers of alerts that continue to require their attention, e.g., to be processed in some way, for example, approving transactions, acknowledging market and/or fund conditions and/or recording data associated with such events, etc. Furthermore, the compliance alert component 310 may also be configured to generate information and/or alerts regarding data exception alerts, which may require the checking of integrity or correctness of data indicative of market and/or fund activity. The compliance alert component 310 may provide various alerts including, for example, a batch compliance concentration alert (produced by the batch compliance concentration alert component 335), a batch compliance exclusion alert (produced by the batch compliance exclusion alert component 340), an account compliance summary (including, for example, account compliance summary information 315), a bucket concentration alert (including, for example, bucket concentration data 330), etc.

Thus, the CCO Support System may include components configured to deliver functional data, on a timely basis, to assist a Client's CCO in monitoring and reporting on post-trade compliance, fund cash flows from fund capital stock activity and fair valuation practices.

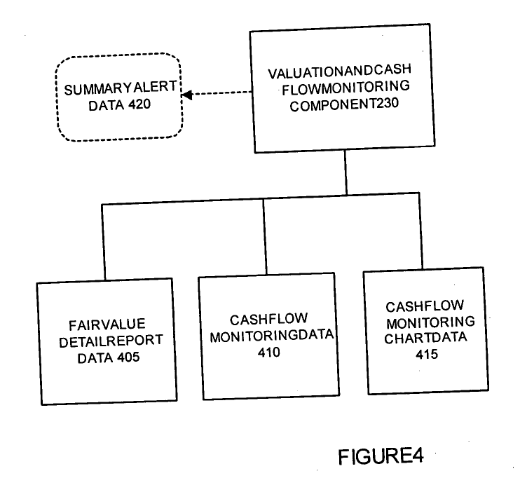

As illustrated in FIG. 4, the valuation and fund cash flows monitoring component 230, illustrated in FIG. 2, may include or provide access to, for example, fair value detail report data 405, fund cash flow monitoring data 410 and fund cash flow monitoring chart data 415.

Fair value detail report data 405 may include various information such as the fair value market value adjustment, the open market value adjustment, net assets calculated using closing, fair value and opening security prices, the difference between the NAV at fair value versus the NAV at close, the difference between the NAV at open versus the NAV at close, the difference between the NAV at open versus the NAV at fair value, an indication as to whether the fair value NAV is directionally correct and closer to open and the related variance reduction.

Fund cash flow monitoring data 410 may include data associated with trading of fund shares including account number, fund name, date of transaction, net assets at time of transaction, net flow, capital stock turnover ratio for subscriptions, capital stock turnover ratio for redemptions, turnover ratio spread, netflow ratio, bias index, NBI index and a total number of points used to provide an indication as to whether market timing significant to a fund may be taking place based on one or more cash flow monitoring algorithms.

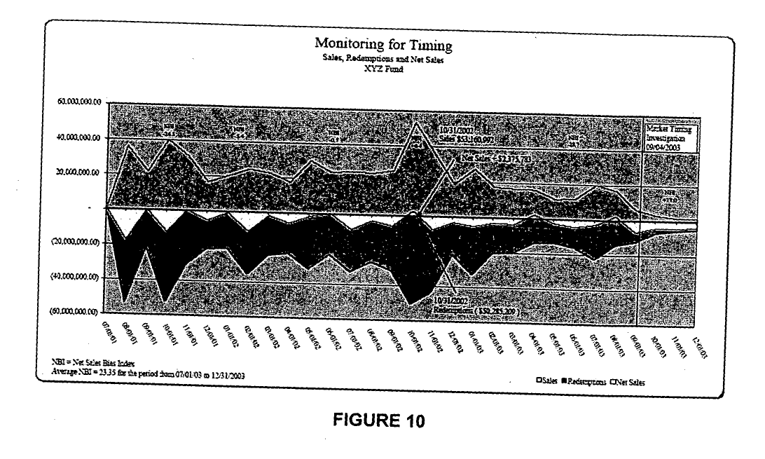

One of the requirements of Rule 38-A-1, referenced above, is the monitoring of fund cash flows associated with its capital stock activity, i.e., sales, redemptions, and net sales. Fund cash flows monitoring component 230 documents capital stock activity and provides details regarding ratios of subscriptions and redemptions in relationship to the total amount of net assets of a fund. Cash flow monitoring chart data 415 may include data necessary to produce a chart such as the one illustrated in FIG. 10 discussed herein and include some of the information necessary to enable satisfaction of the requirements of Rule 38-A-1 with regard to cash flow monitoring.

The valuation and cash flow monitoring component 230 may also be configured to generate summary alert data 420 that may include various information associated with fair value alerts triggered during a particular period of time, e.g., on a particular day, during a particular week, month, quarter or year. Such information may include information associated with one or more triggers of alerts, explained in more detail herein with relation to FIG. 12. For example, a fair value summary of alerts may be issued for a particular fund for a particular period of time, e.g., one day, week, month, quarter, year, etc. That fair value summary of alerts may include information associated with the time period's trigger measurement, e.g., SPX 500 trigger measurement data associated with, for example, asian and european triggers, net asset values, effectiveness indicator data which are various measurements of the effectiveness of the fair value methodology and post market closing price trigger measurement data which is the measurement of the change in the SPX 500 from the close of the US market and the opening of the relevant foreign market.

Thus, the CCO Support System may be configured to monitor and document post-trade compliance of Client portfolios , fund cash flows and fair valuation practices.

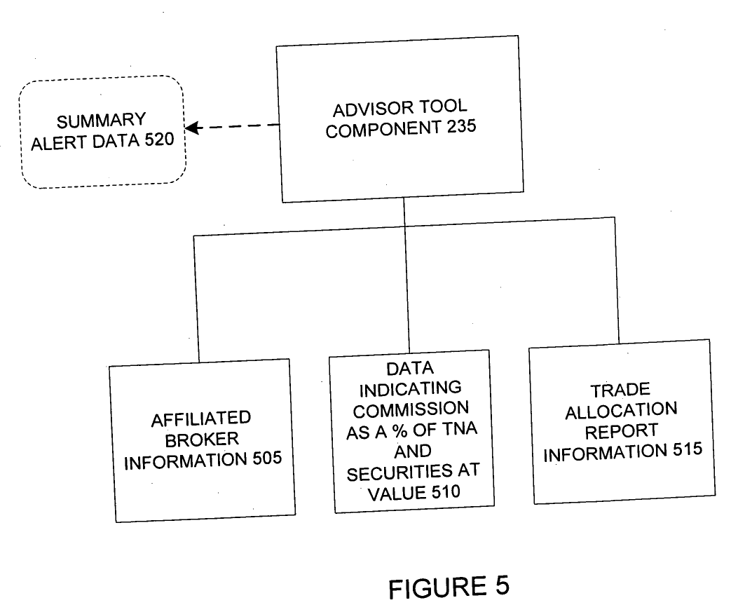

As illustrated in FIG. 5, the advisor tool component 235, illustrated in FIG. 2, may include or provide access to affiliated broker information 505 indicating the identity of brokers affiliated with a particular fund or their advisors and select details of such trades, data 510 indicating their commissions as a percentage of Total Net Assets (TNA), and trade allocation report information 515 which may include information listed by account number and an indication of the type of transaction(s), cusip, the particular security subject of the transaction(s), the trading broker, the trade date, shares/par involved in the transaction(s), price, principal, commission (if any) commission rate, information indicating what percentage of a period's trades the transaction(s) represents, percentage of total assets affected by the transaction(s) and percentage of the involved securities value.

Thus, the CCO Support System may support monitoring and documenting information and post-trade compliance data in addition to the post-trade compliance component 225, as illustrated in FIG. 3, for advisors associated with a particular fund. Accordingly, the CCO Support System may be configured to assist a Client's CCO in measuring the effectiveness of fund and advisor policies and procedures designed to prevent the violation of federal securities laws.

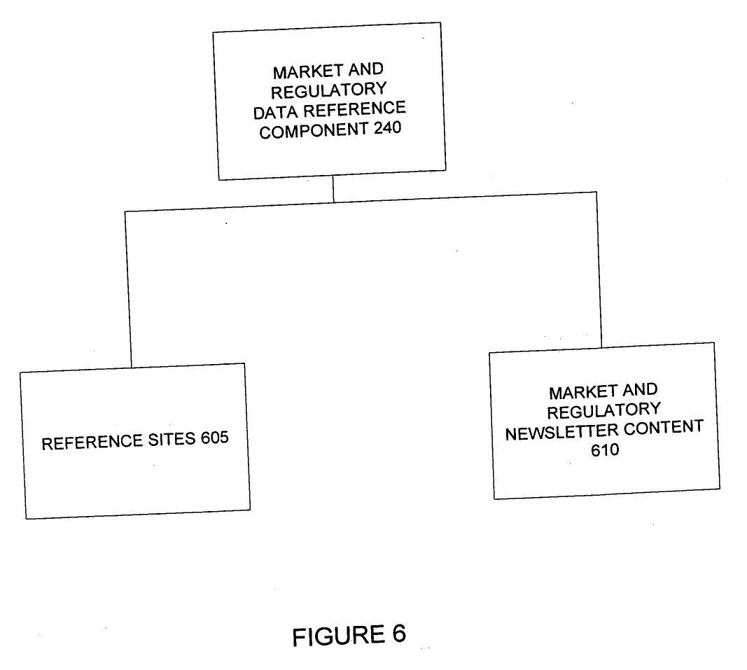

As illustrated in FIG. 6, the market and regulatory data reference component 240, illustrated in FIG. 2, may include or provide access to a reference sites component 605 and market and regulatory newsletter content component 610. The reference sites component 605 may provide access to, via display of various links to regulatory and governmental web-sites and other pertinent qualitative data generated and delivered by independent, third parties, for example, third parties independent of the customer who may be a mutual fund advisor and, as a result, subject to requirements or market pressure to provide such independent, third party analysis.

Thus, the CCO Support System also may include a reference data repository system component which provides both web-based access to essential documentation and pertinent industry literature along with content management functionality. Such documentation and industry literature may include reference materials, for example, information generated by the Financial Accounting Standards Board, the Investment Company Institute, the National Association of Securities Dealers, Inc., the Securities Industry Association, the U.S. House Committee on Financial Services, the U.S. Treasury Department, the Wall Street Journal, etc. The platform may also provide access to reference materials such as statutes, regulations and related information including, but not limited to, Edgar filings, Final Rule 38A-1 IA-2204, the Securities Act of 1933, the Trust Indenture Act of 1939, the Investment Company Act of 1940, the Investment Advisers Act of 1940, the Bank Secrecy Act of 1998, the Gramm-Leach-Bliley Act of 1999, the Sarbanes-Oxley Act of 2003, Rule 10f-3 (relating to exemptions for acquisitions of securities during the existence of an underwriting), Rule 17a-7 (relating to exemptions of certain transactions between an investment company and affiliated persons), Rule 17e-1 (relating to affiliated brokers) and other rules and regulations issued by the U.S. Securities Exchange Commission. Additionally, the platform may provide access to proposed rules by NASDAQ, NYSE and the SEC. The documentation and industry literature may be provided in various formats including PDF/Excel file formats or through hyperlinks to data files including the documentation and literature.

Thus, all information provided by the CCO Support System may be available on-line. Accordingly, there may be no need to order materials that are subsequently provided in hard copy via traditional shipping carriers. Rather, a user may simply access the document(s) of interest and download those documents to the user's system. Subsequently, the user may either view the documents on a computer screen and/or print out one or more copies of documents as CCO Support System policy may dictate.

Thus, the CCO Support System may include components configured to enable access to legal literature, industry and regulatory data that is pertinent and directly applicable to the responsibilities of the CCO in carrying out their duties.

In addition to the regular monitoring of critical information that must be performed, the new CCO rules have become a cause for concern for many in the industry as volumes of documentation must be developed and maintained to demonstrate compliance with the rules and regulations impacting their business. Thus, the CCO Support System also may provide content management functionality.

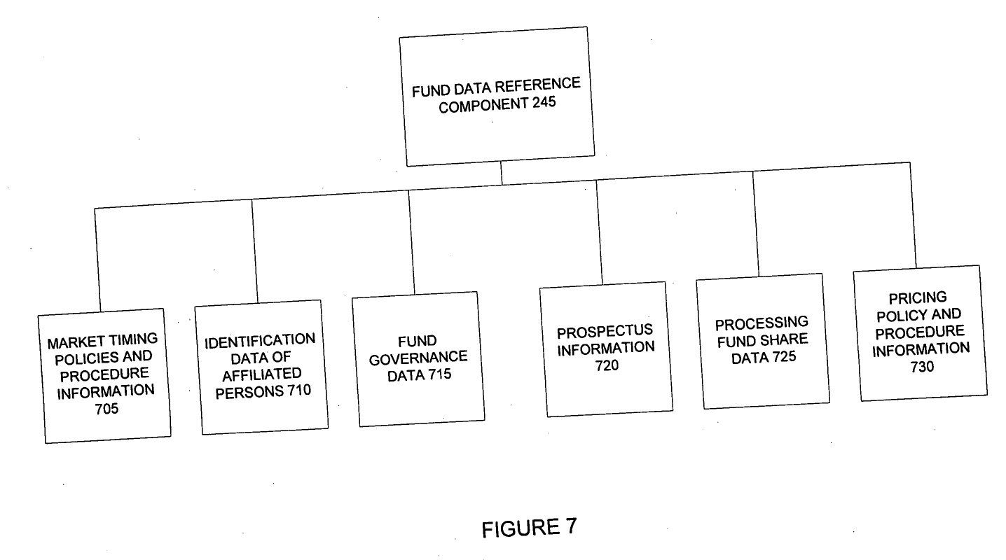

As illustrated in FIG. 7, the fund data reference component 245, illustrated in FIG. 2, may provide a tool for recording and documenting market timing policies and procedure information 705, identification data of persons affiliated with one or more funds and/or transactions 710, fund governance data 715, associated prospectus information 720, processing fund share data 725, and pricing policy, procedure information 730, and any other fund-related information.

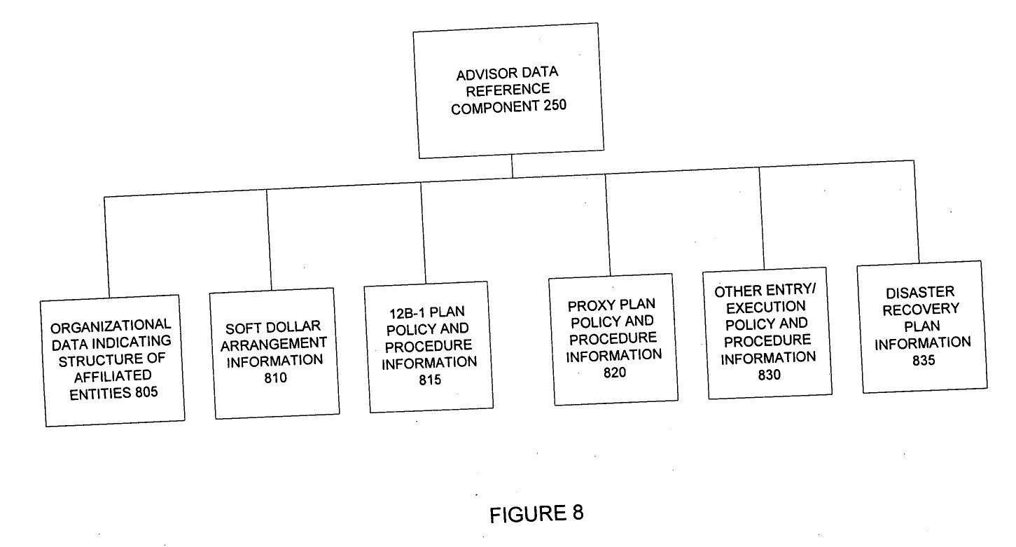

As illustrated in FIG. 8, the advisor data reference component 250, illustrated in FIG. 2, may provide a tool for recording and documenting organizational data indicating structure of affiliated entities 805, soft dollar arrangement information 810, 12B-1 plan policy and procedure information 815, proxy plan policy and procedure information 820, other entry/execution policy and procedure information 830, disaster recovery plan information 835, and any other advisor-related information.

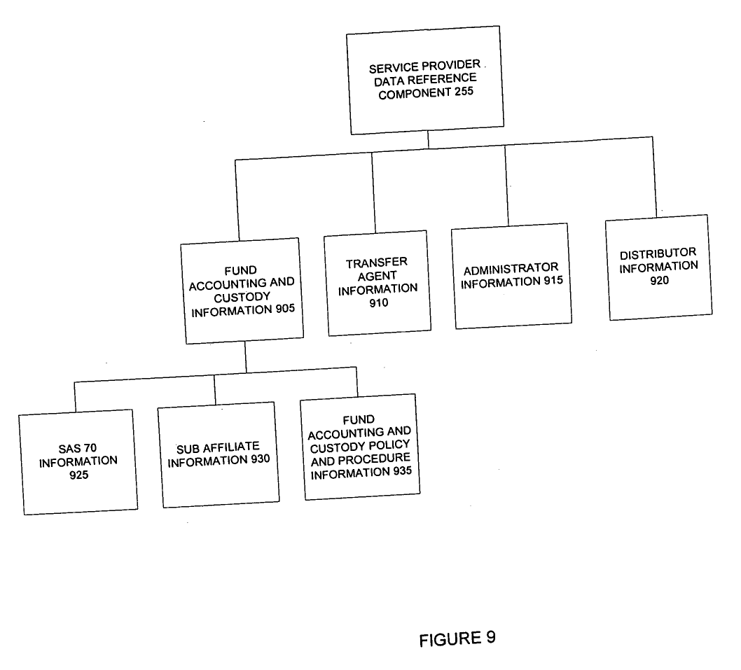

As illustrated in FIG. 9, the service provider data reference component 255, illustrated in FIG. 2, may provide a tool for recording and documenting fund accounting and custody information 905, transfer agent information 910, administrator information 915, and distributor information 920. The fund accounting and custody information 905 may include SAS 70 information 925, sub affiliate information 930, fund accounting and custody policy and procedure information 935, and any other service provider information.

Thus, the CCO Support System may be configured to provide a repository of documentation required to be maintained by the new CCO rules and proprietary fund information that is pertinent and directly applicable to the responsibilities of the CCO in carrying out their duties.

Therefore, to address the issue of access and retention, the CCO Support System provides access to a reference data repository combined with content management functionality. Thereby, in addition to enabling regular monitoring of required critical information, the CCO Support System may provide access to and management of the large volumes of documentation required under the new CCO rules to be developed and maintained to demonstrate compliance.

Subsequent to Client personnel populating a document available via the CCO Support System with data specific to the Client, the CCO Support System then stores that populated document f or subsequent reference by the Client. In this regard, the CCO Support System stores such documents in an organized manner that allows a Client CCO (including their personnel and/or staff members) to access such documents as necessary for an indefinite period of time via, easy and secure web-based access. Such documents may include reference materials as well as documents that may be populated with data by the Client to document activities performed by Client personnel and/or affiliated parties.

As illustrated in FIG. 10, the data being maintained and accessible through the CCO Support System may be charted in one or more graphical representations to provide improved ease of analysis by Client CCOs. Such charting functionality may be provided by various components of the CCO Support System and may be facilitated by a Client CCO accessing the alert messaging center and/or the reports center described in more detail with relation to FIG. 11.

FIG. 10 illustrates one example of a potential configuration of a chart including information derived by monitoring and documenting fund cash flows as performed, for example, by the valuation and cash flow monitoring component 230 illustrated in FIG. 4 based on cash flow monitoring data generated as a result of performing one or more cash flow monitoring algorithms on fund sale, redemption and net sale transaction data.

Such graphical representations of, for example, data recorded for performing monitoring of fund cash flows (as in FIG. 10) or industry capital stock activity, may be configured to allow a user to excite (i.e., click on) a particular point or region of the graphical representation to trigger display of additional data (in textual or graphical form) associated with that point or region. Providing a Client CCO with this ability to chart data provided by the compliance system and fund accounting components allows for high level monitoring of data as well as charting and drill-down analysis of data details.

FIG. 11 illustrates one example of a web-page configured as a home page for the CCO Support System. As illustrated in FIG. 11, the home page 1100 may include introductory information 1110 that provides information for users wanting to access the CCO Support System, a message center 1120 that displays data associated with or included in one or more alerts and summaries generated for the CCO by the CCO Support System. Such alerts and alert summaries may be displayed on a web-page that may be displayed to the CCO upon accessing the CCO Support System following entry of identification data and password (this requirement may be eliminated subsequent to an initial visit to the home page provided that the user indicates that their identity and password should be remembered and associated with a particular access device, e.g., a personal computer). By exciting, i.e., clicking on, various alerts and/or the content of those alerts, a Client CCO may access additional data associated with the subject matter of the alert in textual and/or graphical format.

The home page 1100 may also include various links 1130 to, for example, reference materials maintained by the organization associated with the CCO Support System (e.g., newsletters such as a Red Top Newsletter, an example of which being illustrated in FIG. 12), compliance reference web-sites (providing information and/or documents associated with the new CCO rules and other pertinent regulations), and/or one or more pages associated with fund accounting and other services provided by the organization associated the CCO Support System. The page 1100 may also include a series of pull down menus and/or links 1140 associated with a reports center supported by and provided by the CCO Support System, a profile page enabling a Client CCO to input and/or change information included in the Client CCO's profile, e.g., authorized users, fund information, documentation requirements, organization information, policies, standing instructions for generating alerts (explained in more detail herein), etc.

The message center 1120 may include both alerts and alert summaries specific to a Client CCO. As discussed above, various types of alerts may be issued for funds, including illiquid securities, security type, 12D3, non-U.S. Equity, 17e-1. Additionally, the summary of alerts may be generated, transmitted and/or stored by the CCO Support System for a particular period of time, e.g., a particular day. Such a summary may include data broken down into listings of compliance concentration alerts and affiliated broker alerts. For each alert listed, the summary may also include information indicating the alert percentage limit value, the actual percentage value and a comparison between the actual and alert limit percentage value.

As explained above, the CCO Support System may issue alerts based on standing instructions set forth by a Client CCO. For example, standing instructions may indicate that fair value prices should be applied when the Russell 1000 Index changes by 75 basis points from a prior close.

In such scenarios, various pieces of information may be monitored, recorded, and included in a corresponding alert or report; such information may include, for example, the trigger date, i.e., the date on which the condition included in the standing instructions occurred, the current close position, prior close position, change and amount of basis points for the specified index, i.e., the Russell 1000 Index. Additionally, the information may include similar or the same information for various global indices including the Dow Jones Industrial Average, S&P 500 Index, the NASDAQ Composite Index, Russell 2000 Index, Russell 3000 Index, FTSE 100 Index, CAC 40 Index, DAX Index, NIKKEI 225, Hang Seng Index, etc. Similarly, the standing instructions may indicate more then one trigger, e.g., an asian market trigger in which, the S&P 500 future changes by, for example, 100 basis points, between the GLOBEX 2:00 a.m EST and the CBOE 4:00 p.m. EST, and a european trigger, in which, the S&P 500 future changes by, for example, 100 basis points between the CBOE 11:30 a.m EST and the CBOE 4:00 p.m. EST.

Additionally, in accordance with at least one embodiment of the invention, the CCO Support System may provide for flexible reporting and customized formats. Thus, in accordance with at least one embodiment of the invention, potential violations of an implemented policy may be communicated as alerts in the message center 1120 as well as directly to various devices including a personal data assistant of a CCO.

Thus, it should be understood that FIGS. 2-9 describe components that implement a back-end of the CCO Support System whereas FIG. 11 illustrate one page of a web-enabled front-end of that CCO Support System. Therefore, it should be understood that the alerts listed in the alert messaging center 1120 are a result of the operation and cooperation of various components illustrated in FIGS. 2-9. Similarly, the links 1140 are provided and supported by various components, for example, the market and regulatory data reference component 240 illustrated in FIG. 6. Moreover, the report center accessible via the links 1140 enables Client CCOs to generate various reports in an automated, semi-automated or ad hoc fashion based on their analytic and record keeping needs as a result of the operation and cooperation of various back-end components illustrated in FIGS. 2-9.

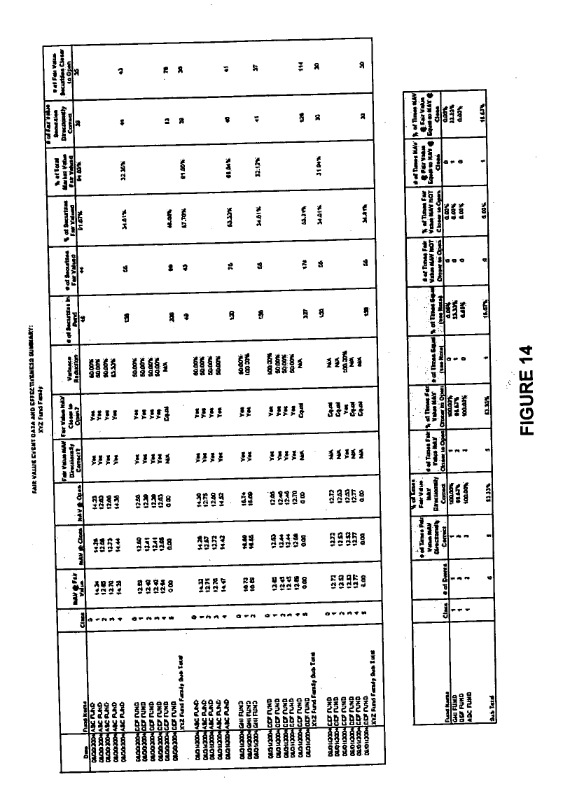

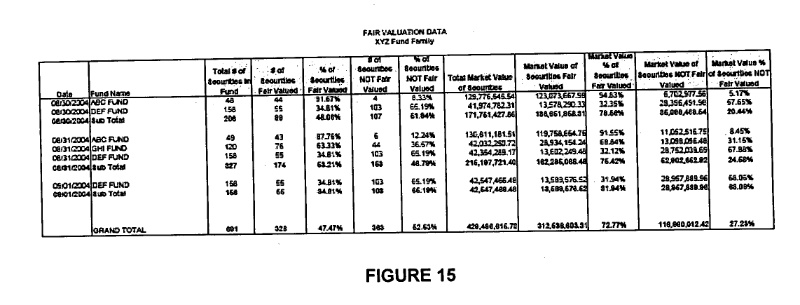

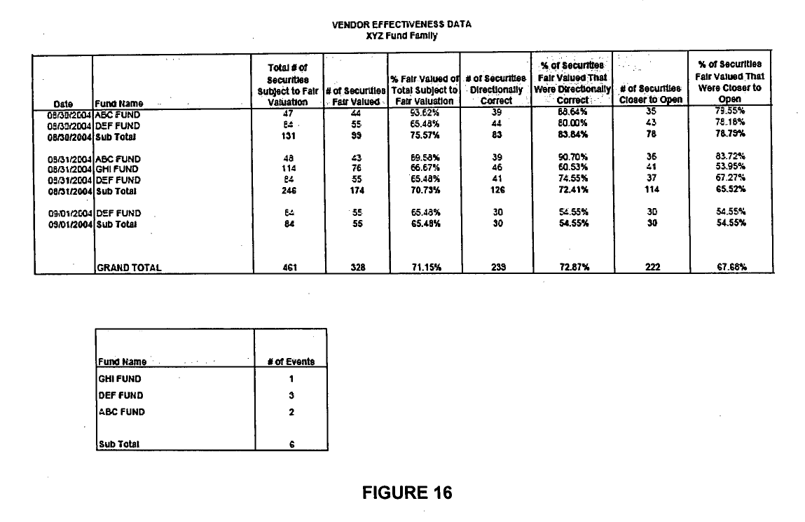

For example, as illustrated in FIGS. 13-16, various reports may be included in the CCO Support System including a Fair Value Detail report (FIG. 13), a Fair Value Event Data and Effectiveness Summary report (FIG. 14), a Fair Valuation Data report (FIG. 15) and a Vendor Effectiveness Data report (FIG. 16).

As illustrated in FIG. 13, the information included in the Fair Value Detail report may include information for a particular account including the number of active share classes, market value adjustments, net asset values (original, fair value, open after capital changes), allocation percentages, outstanding shares, net asset value per share (original, fair value, opening price, difference between fair value and original, difference between opening price and original, difference between opening price and fair value, percentage difference between original and fair value), an indication whether the fair value net asset value was directionally correct and whether it was closer to the value at open and a variance reduction.

The Fair Value Event Data and Effectiveness Summary report (such as the example illustrated in FIG. 14) may be formatted to include data for particular fund events and include information such as the net asset valuation (at fair value, at close, and at open), an indication of whether the fair value new asset valuation was directionally correct and whether it was closer to open, as well as, an indication of a variance reduction percentage. The report may also include an indication of the number of securities in the fund being reported on, the number of securities being fair valued and the percentage of securities in the fund being fair valued, a percentage of the total market value being fair valued, the number of fair valued securities that are directionally correct and the number of fair value securities closer to open. That report may also include a report summary that indicates how many funds are being reported on in the report and various information associated with each of the funds being reported on.

A Fair Valuation Data report (FIG. 15) may include data broken down by, for example, date, for each fund of interest to a Client CCO. Each entry may be associated with a particular fund on a particular day and include, for example, an indication of the date, the fund name, the total number of securities in the fund, the number of securities having been fair valued, the percentage of securities being fair valued, the number of securities not being fair valued, the percentage of securities not being fair valued, the total market value of the securities in the fund, the market value of the fair valued securities and corresponding market value percentage, the market value of the securities not fair valued and the corresponding market value percentage.

A Vendor Effectiveness Data report (FIG. 16) may include data associated with a particular vendor, broken down by, for example, date, for each fund of interest to a Client CCO. Each entry may be associated with a particular fund on a particular day and include, for example, an indication of the date, the fund name, the total number of securities subject to fair valuation, the number of securities fair valued, the percentage fair valued of the total subject to fair valuation, the number of securities that were directionally correct and the corresponding percentage, and the number of securities that were closer to open and the corresponding percentage. That report may also include a report summary that indicates how many fair value events have occurred in each funds.

Although not illustrated, a fair value detail report may be formatted to include information for a particular date and include a breakdown of information for each security supported by the CCO Support System. That information may include security number, security description, shares/par, original price, fair value price, original to value price change percentage, fair value net asset value impact, open price, original to open price change percentage, opening price net asset value impact, an indication if the fair value is directionally correct, an indication of whether the fair value price is closer to open and a variance reduction percentage. That report may also include a report summary that indicates various information associated with the detail being reported on.

Thus, the CCO Support System delivers functional data, on a timely basis, to assist a Client's CCO in measuring the effectiveness of fund and advisor policies and procedures designed to prevent the violation of federal securities laws. The CCO Support System may also be configured to monitor and document post-trade compliance of Client portfolios, cash flow monitoring and fair valuation practices. Additionally, the CCO Support System may include components configured to provide a repository of documentation required to be maintained by the new CCO rules. Further, in accordance with at least one embodiment of the invention, the CCO Support System may include components that enable access to legal literature, industry and regulatory data, and proprietary fund information that is pertinent and directly applicable to the responsibilities of the CCO in carrying out their duties.

It should be understood that the components described herein may be implemented in many different ways including as software applications that are operating and cooperating on one or more servers maintained by the organization providing the CCO Support System. It should also be understood that these servers may include or interact with large quantities of memory that may store data utilized by and/or generated by the CCO Support System.

It should be understood that the system and the results provided by them are intended to provide an indication as to whether market timing significant to a fund may be taking place. Thus, the system cannot provide guaranteed detections of market timing activity and must be used together with other monitoring and detection systems and mechanisms.

While the embodiments of the present invention may provide a mutual fund CCO, or other personnel providing services on behalf of a mutual fund or other investment vehicle, with a powerful tool, the invention may have utility in other heavily regulated business environments, which may require the calculation and reporting of data, significant and complex document retention responsibilities, where a centralized group must oversee compliance via the monitoring of data, where a high volume of documentation must be created and maintained or where a multitude of rules and laws must be followed.

What is claimed is:

1. A system configured to support compliance with fund and advisor policies and procedures designed to prevent the violation of federal securities laws, the system comprising:
at least one functional resource component providing at least one analytic tool for determining compliance with at least one of the new CCO rules; and
at least one data reference resource component providing access to reference material associated with the new CCO rules.

2. The system of claim 1, wherein the system monitors and documents post-trade compliance of client portfolios, cash flow monitoring and fair valuation practices.

3. The system of claim 1, wherein the system provides a repository of documentation required to be maintained by the new CCO rules.

4. The system of claim 1, wherein the system enables access to legal literature, industry and regulatory data, and proprietary fund information.

5. The system of claim 1, wherein the front end of the system is web-based.

6. The system of claim 1, wherein one or more Clients access the system via a communication network and interact with one or more web-pages provided by a front end of the system.

7. The system of claim 1, wherein the system provided electronic storage, maintenance and tracking of all of a Client's documentation.

8. The system of claim 1, wherein the system utilizes at least one security measure associated with access of the system by a user.

9. The system of claim 8 wherein the at least one security measure utilizes a user-input identification number and password.

10. The system of claim 8, wherein the at least one security measure utilizes secure socket technology.

11. The system of claim 8 wherein the at least one security measure utilizes encryption.

12. The system of claim 1, wherein the system receives the compliance monitoring and reporting data regarding at least one fund from an integrated compliance data monitoring and reporting component.

13. The system of claim 1, wherein the system receives the compliance monitoring and reporting data from a Client-specific compliance data monitoring and reporting component.

14. The system of claim 1, wherein the at least one functional resource component is a post trade compliance monitoring component configured to provide detailed and summary information including at least one report of account compliance summary information, concentration of position data, account concentration data, information relating to exemptions for the acquisition of securities during the existence of an underwriting, information relating to exemptions of certain transactions between an investment company and certain affiliated persons, information related to affiliated brokers, and bucket concentration data.

15. The system of claim 14, wherein the post trade compliance monitoring component is configured to provide information as part of an alert, an alert summary or in a report accessible by a Client CCO.

16. The system of claim 1, wherein the at least one functional resource component is a valuation and cash flow monitoring component configured to provide at least one of information fair valuation of one or more securities in a portfolio, market indices data and cash flow monitoring data.

17. The system of claim 1, wherein the at least one functional resource component is a valuation and cash flow monitoring component configured to monitor and document post-trade compliance of Client portfolios, cash flow monitoring and fair valuation practices.

18. The system of claim 1, wherein the at least one functional resource component is an advisor tool component configured to support documenting information and associated data for advisors associated with brokers associated with a particular fund.

19. The system of claim 1, wherein the at least one data reference resource component is a market and regulatory data reference component configured to provide access to a reference data repository system component which provides both web-based access to essential documentation and pertinent industry literature that is applicable to the responsibilities of a client CCO.

20. The system of claim 1, wherein the at least one data reference resource component is a fund data reference component configured to record and document market timing policies and procedure information, identification data of persons affiliated with one or more funds and/or transactions, fund governance data, associated prospectus information, processing fund share data, and pricing policy and procedure information.

21. The system of claim 1, wherein the at least one data reference resource component is an advisor data reference component configured to record and document organizational data indicating structure of affiliated entities, soft dollar arrangement information, 12B-1 plan policy and procedure information, proxy plan policy and procedure information, other entry/execution policy and procedure information and disaster recovery plan information.

22. The system of claim 1, wherein the at least one data reference resource component is a service provider data reference component configured to record and document fund accounting and custody information, transfer agent information, administrator information, and distributor information.

23. The system of claim 1, wherein the at least one functional resource component is configured to generate at least one electronic alert message in response to the at least one functional resource component determining that an alert trigger has been met for compliance monitoring and reporting data associated with at least one fund.

24. The system of claim 23, wherein the alert trigger enables automated and/or semi-automated generation of message alerts dealing with portfolio compliance to warn a Client CCO that a portfolio has fallen outside of minimum or maximum concentrations in a particular country, region, industry, issuer, investment type, or tax status.

25. The system of claim 23, wherein the system further comprises a web-based front end and the electronic alert message is displayed in an alert message center included in a home page displayed by the front end of the system.
